(19) United States
(12) Patent Application Publication
(10) Pub. No.: US 2007/0035784 A1
(43) Pub. Date: Feb. 15, 2007

(54) Image processing method and apparatus

(75) Inventors: Naohiro Ariga, Tokyo (JP); Hitoshi Ueda, Tokyo (JP)

Correspondence Address: Thomas Spinelli;Sully, Scott, Murphy & Presser, 400 Garden City Plaza, Garden City, NY, 11530, US

(73) Assignee: Olympus Corporation, Tokyo (JP)

(21) Appl. No.: 11/497,713

(22) Filed: Aug. 2, 2006

(30) Foreign Application Priority Data
Aug. 10, 2005 (JP) 2005-232523

(51) Int. Cl. H04N 1/40

(52) U.S. Cl. 358/461

(57) ABSTRACT

The present invention discloses an image processing method for correcting shading based on the approximated surface of a brightness distribution of an image acquired with a digital camera. In the image processing method, a function describing the approximated surface is transformed into a shading correction function to correct the shading of the image and hence to form a shading-corrected image. Then, a shading correction function changed for the shading-corrected image formed is applied to perform shading correction once again. Additionally in the method, a parameter can be added to a term of given order of the function describing the approximated surface determined from the image to perform correction using a shading correction function the parameter value of which is changed by the added parameter.

### CROSS-REFERENCE TO RELATED APPLICATION

This application is based upon and claims the benefit of priority from prior Japanese Patent Application No. 2005-232523, filed on Aug. 10, 2005, the entire contents of which are incorporated herein by reference.

### BACKGROUND OF THE INVENTION

1. Field of the Invention

The present invention relates to an image processing method and apparatus for correcting shading (unevenness of brightness) appearing in an image acquired with a digital camera. The term “digital camera” used here includes the term “digital video camera.” In particular, the present invention relates to an image processing method and apparatus for correcting shading appearing in an image acquired with a digital camera attached to an optical microscope.

2. Description of the Related Art

In an image acquired with a digital camera, brightness on the periphery of the image plane often becomes lower than that around the center due to, for example, the influence of an imaging lens or illumination. When an image observed under the microscope is captured, the occurrence of shading disturbs the observation of an object. Japanese Patent Laid-Open No. 05-227428 and 2000-276581 disclose techniques for determining an approximated quadratic curve or surface to approximate a brightness distribution of an image in which shading is present to correct the shading automatically based on the approximated curve or surface. In these publications, an approximated curve or surface of the brightness of an image is automatically determined to correct shading automatically and output a corrected image. Therefore, if an approximated curve or surface showing a good approximation cannot be determined, the correction level of shading is often so excessive that the periphery of the image plane will go too bright in the opposite way, or insufficient for complete correction of shading.

### BRIEF SUMMARY OF THE INVENTION

In the image processing method and apparatus of the present invention for correcting shading based on the approximated surface of a brightness distribution of an image, for example, acquired with a digital camera, the shading of the image is corrected using a function describing the approximated surface as the shading correction function to form a shading corrected image. Then, the shading correction function is changed for the shading-corrected image to perform shading correction once again. Additionally, a parameter can be added to a term of given order of the function describing the approximated surface determined from the image to change the parameter value in order to perform shading correction. According to the present invention, the shading correction method and apparatus enables a user to check the effect of shading correction while viewing the correction result on a screen and perform correction once again as needed.

### BRIEF DESCRIPTION OF THE SEVERAL VIEWS OF THE DRAWINGS

These and other features, aspects, and advantages of the apparatus and methods of the present invention will become better understood with regard to the following description, appended claims, and accompanying drawings where:

FIG. 1 is an illustration showing an example of a GUI to allow a user to adjust the effect of shading correction according to a first embodiment of the present invention;

FIG. 2 is a flowchart showing shading correction processing;

FIG. 3 is a diagram showing the relationship between an image and its approximated surface;

FIG. 4 is a flowchart showing the adjustment of shading correction using a slide bar;

FIG. 5 is a flowchart showing the adjustment of shading correction by entering a numeric value;

FIG. 6 is a flowchart showing processing when a preview switching part is turned on; and

FIG. 7 is an illustration showing an example of a GUI for adjusting the effect of shading correction according to a modification of a second embodiment of the present invention.

### DETAILED DESCRIPTION OF THE PREFERRED EMBODIMENTS

Preferred embodiments of the invention are described below with reference to the accompanying drawings.

### First Embodiment

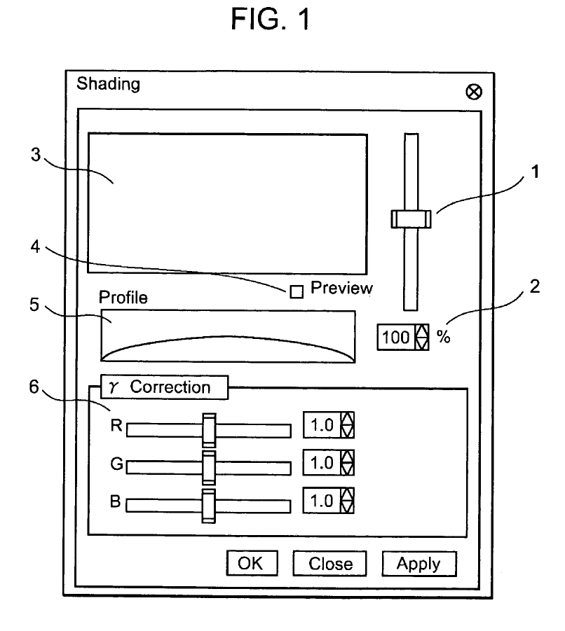

A first embodiment will be described with reference to the accompanying drawings. FIG. 1 is an illustration showing an example of a GUI (Graphical User Interface) for a shading correction device according to the present invention. As shown in FIG. 1, an image processing apparatus for correcting shading includes an image display part 3 to allow a user to check the influence, on shading correction, of the operation of a slide bar 1 or numeric input in a numeric input field 2, both used for adjusting the effect percentage of shading correction. The slide bar 1 and the numeric input field 2 work with each other. In other words, the value in the numeric input field 2 is changed according to the movement of the slide bar 1, while the position of the slide bar 1 is changed in response to a change in the value in the numeric input field 2.

When a preview switching part (preview checkbox) 4 is off (unchecked), an image after subjected to shading correction is displayed on the image display part 3, while when the preview switching part 4 is on (checked), an image before subjected to shading correction is displayed.

A profile display part 5 displays a brightness profile on a specified scanning line of the image displayed on the image display part 3. Since a gamma correction made by Gamma correction means 6 varies the brightness distribution of the image, the shape of an approximated surface for correcting shading also varies. The variation in the shape of the approximated surface corresponds to changes in values c₀, c₁, . . . when the approximated surface is described by the following equation:
F(x,y)=c0×f₀(x,y)+c₁×f₁(x,y)+ . . . (Eq. 1)
where x and y denotes an x coordinate and a y coordinate, respectively, when the position of a corresponding pixel is represented on an xy plane.

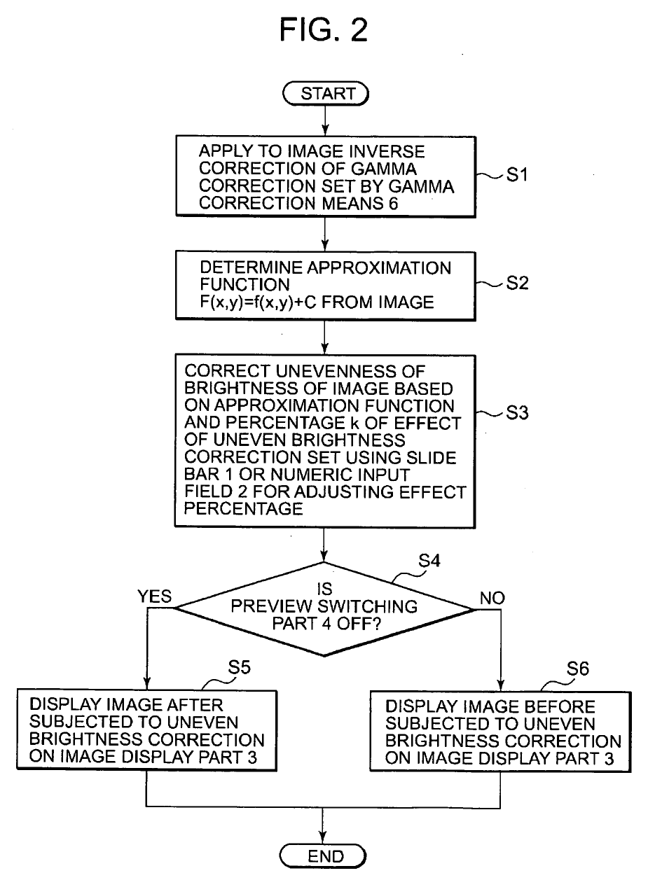

Referring next to the flowchart of FIG. 2, the operation of the first embodiment will be described. First, in step S1, inverse correction of gamma correction based on a gamma value set by the gamma correction means 6 is applied to the image. This is because, when gamma correction is already made for the image on an input/output device, an appropriate approximated surface cannot be determined from the brightness distribution of the image.

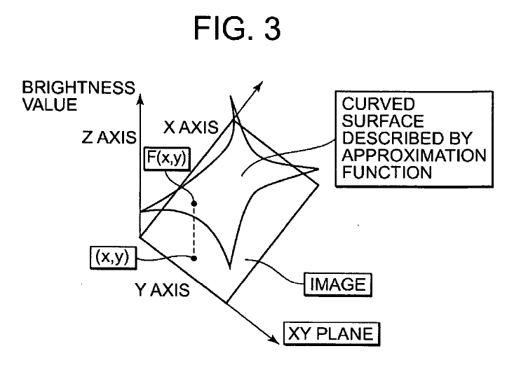

FIG. 3 shows the relationship between brightness and approximated surface when the pixel position of the image is represented on the xy plane. The function F(x,y) describing an approximated surface from an image to which the inverse correction of gamma correction is applied in step S2 is determined by the following equation:
F(x,y)=f(x,y)+C (Eq. 2)
where C is a constant other than 0.

In step S3, the function F(x,y) of the approximated surface determined in step S2 is transformed into function G(x,y,k) with value k set through the slide bar 1 or numeric input field 2 for adjustment of effect percentage, namely:
G(x,y,k)=k×f(x,y)+C (Eq. 3)
Here, it is assumed that representative brightness (intensity) value U is set according to the following equation:
U=G(xc,yc,k) (Eq. 4)
Here, corrected brightness value Inew(x,y) is given by the following equation:
Inew(x,y)=Iold(x,y)×U/G(x,y,k) (Eq. 5)
If the brightness of the entire image is matched with the brightness of the center of the image, brightness value (x_{c},y_{c}) at the center point of the image is set as the representative brightness value U. In the above equation, x_{c} is the center point of the width of the image in the x direction and y_{c} is the center point of the width of the image in the y direction. Iold(x,y) is the brightness value at the pixel position (x,y) of the image before corrected.

Inew(x,y) is determined for all the pixels of the image, thereby making it possible to obtain an image for which shading correction is made.

Note that the following equation can be applied to determine Inew(x,y) instead of the equation 5:
Inew(x,y)=Iold(x,y)+U−G(x,y,k) (Eq. 6)

When this equation is applied, the calculation can be simplified, thereby improving processing response.

In step S4, it is determined whether the preview switching part 4 is on or off. If it is off-state, the procedure goes to step S5 to show the shading-corrected image on the image display part 3. On the other hand, if it is on-state, the procedure goes to step S6 to show the image before shading-corrected on the image display part 3. In this case, the corrected image and the image before the correction may be displayed side by side on the display part 3. This allows the user to adjust the effect of shading correction while viewing the shading-corrected result on the image display part 3. The image displayed on the image display part 3 may be a size-reduced image obtained by thinning out pixels to increase processing speed. Using the reduced image, the function describing the approximated surface or the shading correction function can be determined to perform shading correction. The effect of the shading correction is reflected in the original image with the press of an “Apply” button. Then, the shading-corrected image is enlarged to and displayed in its original size.

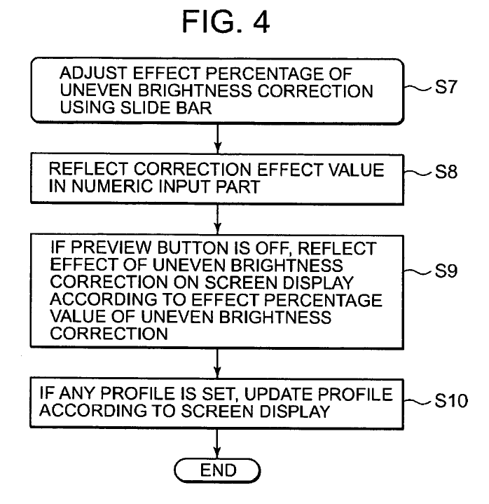

FIG. 4 is a flowchart showing a system operation process to adjust the effect of shading correction according to the movement of the slide bar 1. The movement of the slide bar 1 changes the value in the numeric value field. Then, if the preview switching part is off, the image is updated to an image corrected according to the set effect of shading correction. In this case, the image profile is also updated.

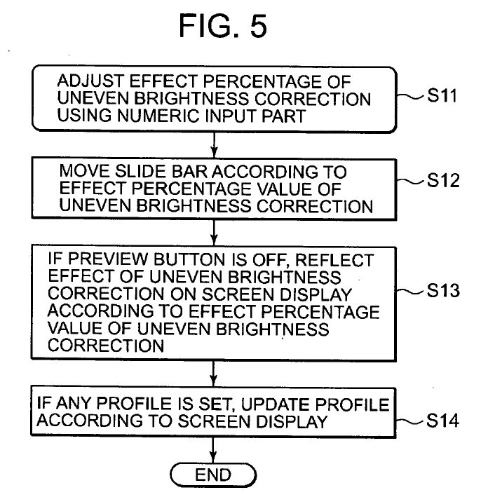

FIG. 5 is a flowchart showing a system operation process to adjust the effect of shading correction according to the input of a numeric value in the numeric input field 2. The input of a numeric value causes the movement of the slide bar 1 to a position corresponding to the numeric value. Then, if the preview switching part is off, the image is updated to an image corrected according to the set effect of shading correction. In this case, the image profile is also updated.

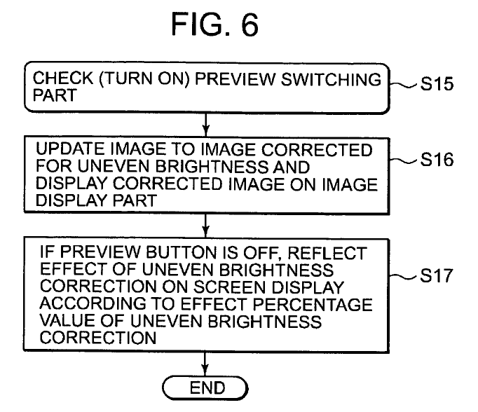

FIG. 6 is a flowchart showing a system operation process to adjust the effect of shading correction when the preview switching part (preview checkbox) 4 is checked. When the preview switching part 4 is turned on, an image before shading-corrected is displayed, while when the preview switching part 4 is turned off, the image is updated to the shading-corrected image. The profile display is also updated according to the updated image. Alternatively, the approximated surface or the shading correction function can be displayed on the image display part 3.

Further, a display part can also be provided separately from the image display part 3 so that the corrected image, the image before corrected, the approximated surface, and the shading correction function will be displayed at a time on the display part.

According to the embodiment, the user can adjust the effect of shading correction in the shading correction process while checking the effect of shading correction on the screen.

### Second Embodiment

The structure of a second embodiment is basically the same as that of the first embodiment. Therefore, the following describes only the point different from the first embodiment. In the second embodiment, it is assumed that the approximated surface determined in step S2 from the image is a quadratic surface and the function F(x,y) of the approximated surface is given by the following equation:
F(x,y)=c₀+c₁x+c₂y+c₃xy+c₄x²+c₅y² (Eq. 7) (
In order to determine the approximated surface from the image, for example, the image is divided into several blocks and c₁ to c₅ in F(x,y) which passes through a sample value in each block, are decided by a least square method. Then, the equation of the approximated surface determined in step S2 is transformed into the following equation with value k set in step S3 through the slide bar 1 or numeric input field 2 for adjustment of effect percentage:
G(x,y,k)=c0+k×(c₁x+c₂y+c₃xy+c₄x²+c₅y²) (Eq. 8)

The operations that follow step S3 are the same as those in the first embodiment, so that their repetitive description will be omitted.

In this embodiment, the approximated surface used in the shading correction process is a quadratic surface. Since the quadratic surface is suited well to an optical model, the second embodiment enables efficient shading correction. In addition, in the process to determine the approximated surface from the image, since the number of coefficients to be determined is six at the maximum in the function describing the quadratic surface, the second embodiment also enables high-speed arithmetic processing.

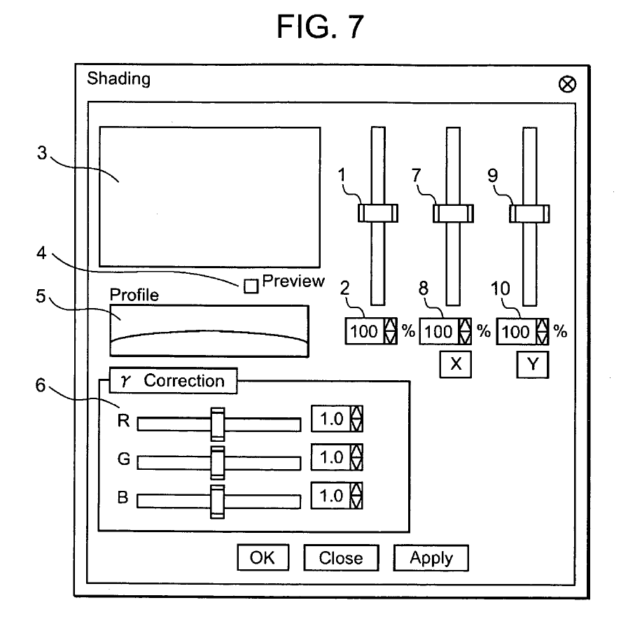

FIG. 7 is an illustration showing an example of a GUI for shading correction according to a modification of the second embodiment. In the structure of this modification, an x-direction slide bar 7 and an x-direction numeric input field 8 for adjusting the effect percentage in the x direction, and a y-direction slide bar 9 and a y-direction numeric input field 10 for adjusting the effect percentage in the y direction are added to the structure of the first embodiment.

In this structure, the x-direction slide bar 7 or the x-direction numeric input field 8, and the y-direction slide bar 9 or the y-direction numeric input field 10 are changed to change the effect of shading correction and hence to display the adjusted image on the image display part 3.

In this modification, only the point different from the first embodiment will be described. It is assumed here that the approximated surface determined in step S2 from the image is a quadratic surface and the function F(x,y) of the approximated surface is given by the following equation:
F(x,y)=c₀+c₁x+c₂y+c₃xy+c₄x²+c₅y² (Eq. 9)

Then, the equation of the approximated surface determined in step S2 is transformed into the following equation using value k, kₓ, and k_{y} set in step S3:
G(x,y,k,kx,ky)=c₀+k(kₓc₁x+k_{y}c₂y+c₃xy+kₓc₄x²+k_{y}c₅y²) (Eq. 10)
where k is a value set through the slide bar 1 or the numeric input field 2, kₓ is a value set through the x-direction slide bar 7 or the x-direction numeric input field 8, and k_{y} is a value set through the y-direction slide bar 9 or the y-direction numeric input field 10, respectively.

The operations that follow step S3 are the same as those in the first embodiment, so that their repetitive description will be omitted.

In this modification, an introduction of the newly added values kₓ, k_{y} as parameters for adjusting the effect of shading correction enables partial adjustments of the effect of shading correction.

The image before subjected to shading correction, the image after subjected to shading correction, images as intermediate products obtained through repetition of shading correction several times are recorded and stored in a storage device. The storage device is incorporated in or connected to the apparatus of the embodiment. Alternatively, a recording medium storing the images can be removed from the apparatus and loaded into another image processing apparatus or computer so that the images will be used for image processing in the another image processing apparatus or computer.

Further, in the above modification, although k and kₓ or k and k_{y} are used for the first- and second-order terms of x or y, respectively, the present invention is not limited thereto and different sets of values can be used as coefficients for the first- and second-order terms, respectively. In the implementation of the present invention, profile data can also be used. In this case, either of both ends of the profile curve is so designated that it will be moved up or down to change the first-order term. At this time, c₀ can be decided to keep the brightness value in the coordinates (x_{c}, y_{c}) constant.

Alternatively, a position other than both ends of the profile curve can also be so designated that it will be moved up or down to change the second-order term. This enables more complicated shading correction.

While there has been shown and described what are considered to be preferred embodiments of the invention, it will, of course, be understood that various modifications and changes in form or detail could readily be made without departing from the spirit of the invention. It is therefore intended that the invention not be limited to the exact forms described and illustrated, but constructed to cover all modifications that may fall within the scope of the appended claims. For example, the approximated surface does not need to be determined from an image, and an approximated surface can be so preset that the present invention will be applied to the preset approximated surface.

What is claimed is:

1. An image processing method for correcting shading based on the approximated surface of a brightness distribution of an image acquired with a digital camera, comprising the steps of:
transforming a function describing the approximated surface into a shading correction function to correct the shading of the image and hence to form a shading-corrected image; and
changing the shading correction function for the shading-corrected image to perform shading correction once again.

2. The method according to claim 1 wherein a parameter is added to a term of given order of the function of the approximated surface or the shading correction function to change the parameter value in order to perform shading correction.

3. The method according to claim 1 wherein a shading-corrected image is displayed.

4. The method according to claim 1 wherein the function describing the approximated surface, or the shading correction function, or the shading correction function with the changed parameter is displayed.

5. The method according to claim 1 wherein the function describing the approximated surface or the shading correction function is determined using an image the size of which is reduced from the size of the original image by thinning out pixels.

6. An image processing apparatus for correcting shading based on the approximated surface of a brightness distribution of an image acquired with a digital camera, comprising:
a shading correction part for transforming a function describing the approximated surface into a shading correction function to correct the shading of the image and hence to form a shading-corrected image,
wherein the shading correction function is changed for the shading-corrected image to perform shading correction once again.

7. The apparatus according to claim 6, wherein the shading correction part adds a parameter to a term of given order of the function of the approximated surface or the shading correction function to change the parameter value in order to perform shading correction.

8. The apparatus according to claim 6 further comprising a display part so that the shading-corrected image is displayed on the display part.

9. The apparatus according to claim 6, wherein the function describing the approximated surface, or the shading correction function, or the shading correction function with the changed parameter is displayed on a display part.

10. The apparatus according to claim 6, wherein the function describing the approximated surface or the shading correction function is determined using an image the size of which is reduced from the size of the original image by thinning out pixels.
